(19) United States
(12) Patent Application Publication
(10) Pub. No.: US 2007/0024388 A1
(43) Pub. Date: Feb. 1, 2007

(54) Slabline structure with rotationally offset ground

(76) Inventors: Hassan Tanbakuchi, Santa Rosa, CA (US); Michael B. Whitener, Santa Rosa, CA (US); Matthew R. Richter, Santa Rosa, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/191,772

(22) Filed: Jul. 27, 2005

(51) Int. Cl. H01P 5/02

(52) U.S. Cl. 333/33

(57) ABSTRACT

A slabline structure includes a first slabline having a first orientation and a second slabline having a second orientation that is rotationally offset from the first orientation. The slabline structure also includes a transition interposed between the first slabline and the second slabline.

### BACKGROUND OF THE INVENTION

A slabline is a transmission structure that is suitable for propagating high frequency electromagnetic signals. A conventional slabline, shown in FIGS. 1A-1B, includes a center conductor that is suspended between a pair of grounds. A slabline has the performance advantage of providing low signal attenuation, especially when air is used as a dielectric between the center conductor and the grounds. The slabline confines electric and magnetic fields of a propagating electromagnetic signal to narrow regions between the suspended conductor and the grounds, which enables the slabline to have a characteristic impedance that can be established according to known design equations, provided for example by Brian C. Wadell in Transmission Line Design Handbook, 1991 Artech House, Inc. ISBN 0-89006-436-9, pages 126, 127, 149. Another advantage of slablines is that a slabline can typically be constructed using conventional fabrication techniques.

As a transmission structure, a slabline can be used to interconnect devices or elements in communication systems, or a slabline can be used to implement filters, couplers, or other circuits. Conventional slablines have a designated orientation that is determined by the relative positions of the center conductor and the grounds. For example, the slabline of FIG. 1A has grounds that are horizontal and positioned above and below the center conductor, which provides a transmission structure that is well suited for implementing couplers, filters or other types of circuits.

However, the slabline in the horizontal orientation is not well suited for mating with components, such as coaxial connectors, integrated circuits, or other transmission structures, such as microstrip transmission lines, due to impedance mismatches that occur at the interface between the slabline in the horizontal orientation and the component. Impedance mismatches cause portions of electromagnetic signals propagating through the slabline to be reflected by the interface, which can degrade the performance of the system within which the slabline is included. In an attempt to reduce impedance mismatches at the interface between the slabline in the horizontal orientation and the component, adjustable impedance-tuning screws are typically included in the slabline structure. Adjusting the impedance-tuning screws can be time consuming and the tuning screws do not always provide an impedance match at the interface.

A slabline in a vertical orientation, shown in FIG. 1B, provides a matched impedance when interfaced with components such as coaxial connectors, integrated circuits, and other transmission structures. Accordingly, there is a need for a slabline structure that is well suited for implementing circuits, such as couplers or filters, that also provides matched impedances when interfacing with components.

### BRIEF DESCRIPTION OF THE DRAWINGS

FIGS. 1A-1B show conventional slablines in horizontal and vertical orientations, respectively.

FIG. 2A shows a top view of a center pin of a coaxial connector mating with a center conductor of a slabline.

FIG. 2B shows a side view of a center pin of a coaxial connector mating with a center conductor of a slabline.

FIG. 3A shows an end view of a center pin of a coaxial connector mating with the center conductor of a vertical slabline.

FIG. 3B shows an end view of a center pin of a coaxial connector mating with the center conductor of a horizontal slabline.

FIG. 4 shows a perspective view of an example of a slabline structure with rotationally offset grounds, according to embodiments of the present invention.

FIGS. 5A-5B show detailed cross-sectional views of the slabline structure of FIG. 4.

FIG. 6 shows an example of a slabline structure with rotationally offset grounds according to alternative embodiments of the present invention.

FIG. 7 shows an example of a coupler implemented in a horizontal slabline within the slabline structure according to alternative embodiments of the present invention.

FIG. 8 shows an example of a reflection S-parameter S₁₁ of the slabline structure.

### SUMMARY OF THE INVENTION

A slabline structure includes a first slabline having a first orientation and a second slabline having a second orientation that is rotationally offset from the first orientation. The slabline structure also includes a transition interposed between the first slabline and the second slabline, providing an impedance match between the first slabline and the second slabline.

### DETAILED DESCRIPTION

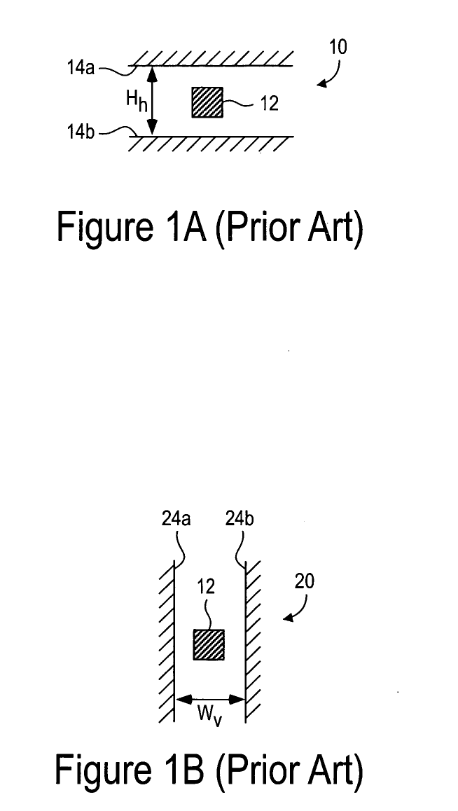

FIG. 1A shows a conventional slabline having a horizontal orientation (hereinafter “horizontal slabline 10”). FIG. 1B shows a conventional slabline having a vertical orientation (hereinafter “vertical slabline 20”). The horizontal slabline 10 has a center conductor 12 with a pair of horizontal grounds 14a, 14b that are separated by a height Hₕ. The horizontal slabline 10 is well suited for implementing couplers, filters and other types of circuits and transmission structures. The vertical slabline 20 has a center conductor 12 with a pair of vertical grounds 24a, 24b that are separated by a width Wᵥ. The vertical slabline 20 is well suited for interfacing to a variety of components, such as coaxial connectors, integrated circuits or other transmission structures such as microstrip transmission lines.

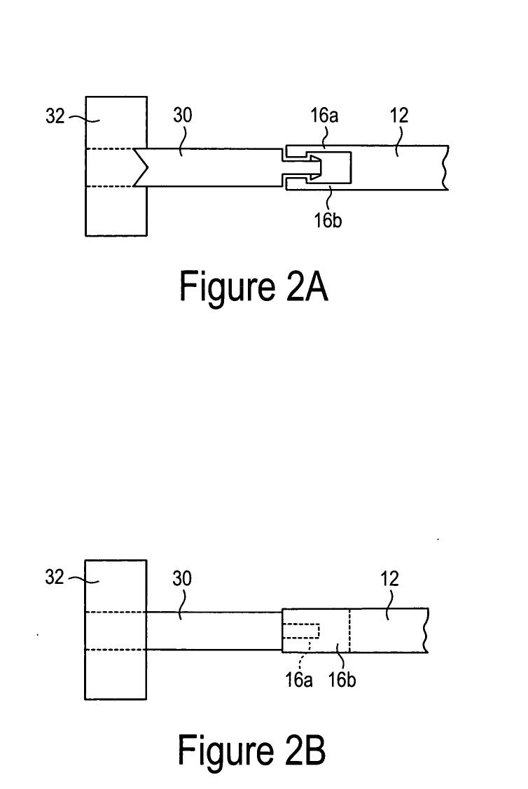

FIGS. 2A-2B show top and side views, respectively, of a center pin 30 of a coaxial connector 32 mating with a center conductor 12 of a slabline. For the purpose of illustration, the grounds of the slabline are not shown in FIGS. 2A-2B. The center conductor 12 of the slabline typically includes a pair of fingers 16a, 16b adapted to receive and contact the center pin 30 of the coaxial connector 32. The mating of the coaxial connector 32 with the slabline provides an interface between the coaxial connector 32 and the slabline.

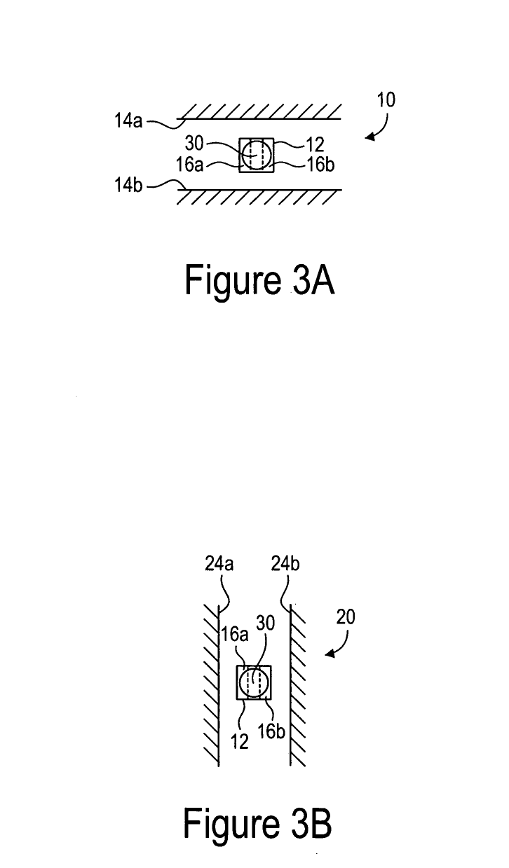

FIG. 3A shows an end view of a center pin 30 of a coaxial connector 32 mating with the center conductor 12 of a horizontal slabline 10, whereas FIG. 3B shows an end view of a center pin 30 of a coaxial connector 32 mating with the center conductor 12 of a vertical slabline 20. The configuration of FIG. 3B provides an impedance match at the interface 33 between the coaxial connector 32 and the vertical slabline 20, due to the resulting physical arrangement of the center pin 30 of the coaxial connector 32 and the fingers 16a, 16b of the center conductor 12 that receive the center pin 30, relative to the grounds 24a, 24b of the vertical slabline 20. The configuration of FIG. 3A results in an impedance mismatch at an interface between the coaxial connector 32 and the horizontal slabline 10, due to the resulting physical arrangement of the center pin 30 of the coaxial connector 32 and the fingers 16a, 16b of the center conductor 12 that receive the center pin 30, relative to the grounds 14a, 14b of the horizontal slabline 10. Accordingly, when interfacing a slabline to a coaxial connector 32, the vertical slabline 20 typically provides a better impedance match to the coaxial connector 32, than the horizontal slabline 10. In addition, the vertical slabline 20 typically provides a better impedance match to integrated circuits, or other transmission structures, than the horizontal slabline 10.

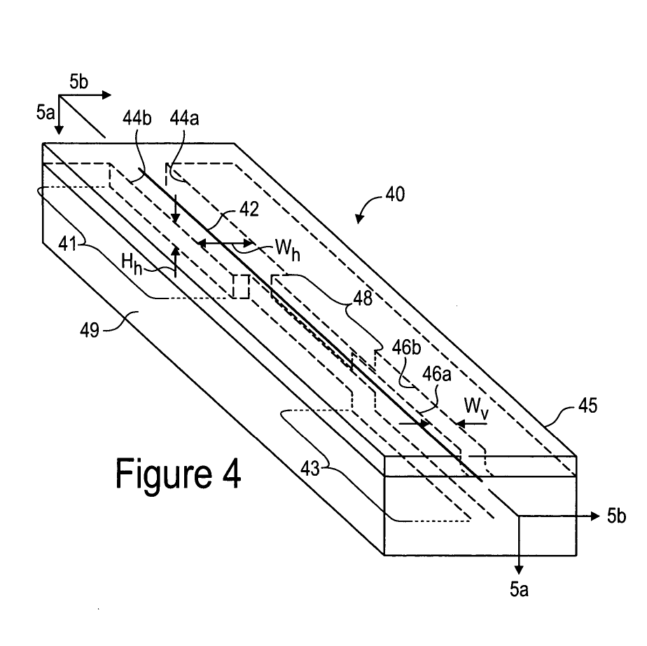

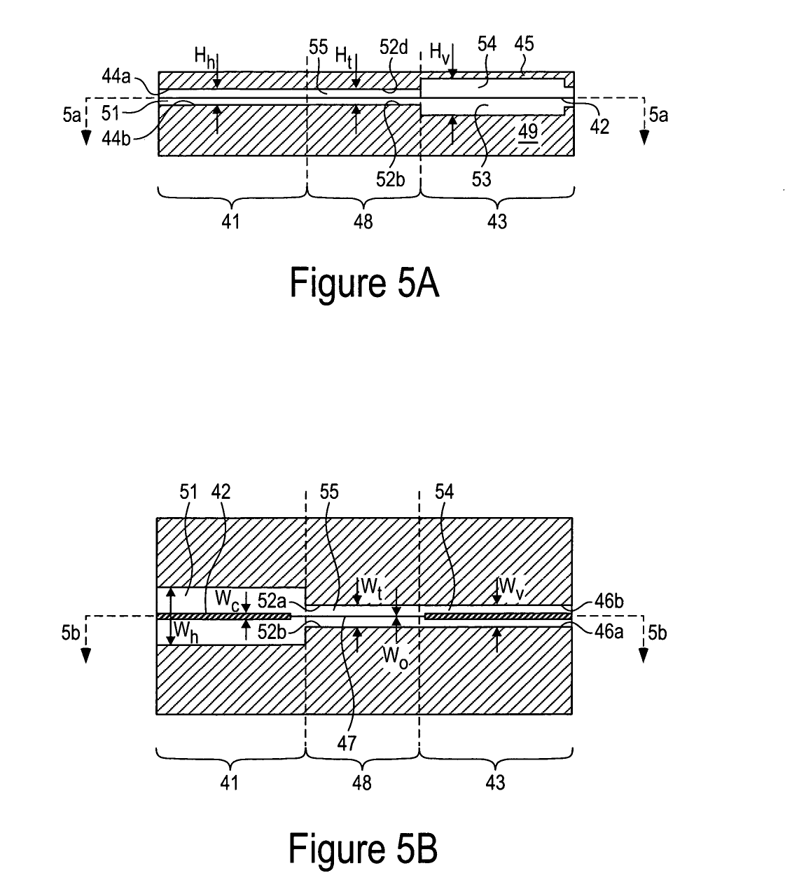

FIG. 4 shows a perspective view of a slabline structure 40 according to embodiments of the present invention. The slabline structure 40 includes a first slabline 41 that has a first orientation, defined according to the relative positioning of the center conductor 42 and the associated grounds 44a, 44b (shown in FIG. 5A). The slabline structure 40 includes a second slabline 43 that has a second orientation, also defined according to the relative positioning of the center conductor 42 and the associated grounds 46a, 46b (shown in FIG. 5B), wherein the orientation of the second slabline 43 is rotationally offset from the orientation of the first slabline 41. The slabline structure 40 also includes a transition 48 interposed between the first slabline 41 and the second slabline 43 that provides an impedance match between the first slabline 41 and the second slabline 43.

While there are a variety of suitable rotational offsets between the relative orientations of the first slabline 41 and the second slabline 43, FIG. 4 provides an example wherein the first orientation is horizontal so that the first slabline 41 is a horizontal slabline, indicated as horizontal slabline 41, and wherein the second orientation is vertical so that the second slabline is a vertical slabline, indicated as vertical slabline 43. In this example, the horizontal slabline 41 is well suited for implementing a coupler, filter, or other circuit, while the vertical slabline 43 is well suited for interfacing to coaxial connectors, integrated circuits or other devices, elements or systems (not shown).

The ground 44b of the horizontal slabline 41 is provided by a bottom surface of a slot 51 in a housing 49 of the slabline structure 40, and the ground 44a of the horizontal slabline 41 is formed by the surface of a lid 45 that is attached to the housing 49. The slot 51 has a width Wₕ that is typically at least three times as great as a spacing, or height Hₕ, between the grounds 44a, 44b of the horizontal slabline 41. The grounds 46a, 46b of the vertical slabline 43 are provided by a slot 53 in the housing 49. The grounds 46a, 46b are separated by a distance, or width Wᵥ. The vertical slabline 43 has a height Hᵥ, formed by a recess 54 in the lid 45 and a bottom surface of the housing 49, wherein the height Hᵥ is typically at least three times as great as the width Wᵥ. The transition 48 interposed between the horizontal slabline 41 and the vertical slabline 43 is formed by three surfaces 52a, 52b, 52c of a slot 55 in the housing 49 and by a fourth surface 52d that is provided by the lid 45. The transition 48 has a height Ht and a width Wₜ.

FIG. 5A shows a detailed view of a vertical cross-section 5a through the horizontal slabline 41, the transition 48, and the vertical slabline 43 shown in the perspective view of FIG. 4. The vertical cross-section of FIG. 5A indicates that the height Hₕ of the horizontal slabline 41 is equal to the height Ht of the transition 48, whereas the height Hᵥ of the vertical slabline 43 is greater than the heights Hₜ, Hₕ. FIG. 5B shows a detailed view of a horizontal cross-section 5b through the horizontal slabline 41, the transition 48, and the vertical slabline 43 shown in the perspective view of FIG. 4. FIG. 5B indicates that the width Wₜ of the transition 48 is equal to the width Wᵥ of the vertical slabline 43, whereas the width Wₕ of the horizontal slabline 41 is greater than the widths Wₜ, Wᵥ. In this example, the designations of the relative heights and widths of the horizontal slabline 41, the transition 48 and the vertical slabline 43 are provided to minimize the number of electrical transitions and discontinuities within the slabline structure 40, and to facilitate fabrication of the slabline structure 40.

The center conductor 42 of the slabline structure 40 is suspended between the grounds 44a, 44b of the horizontal slabline 41, the grounds 52a, 52b, 52c, 52d of the transition 48 and the grounds 46a, 46b of the vertical slabline 43. In the example shown in FIGS. 5A-5B, the center conductor 42 includes an occluded portion 47 wherein the nominal width w_{c} of the center conductor 42 is reduced to a width wₒ. To provide an impedance match through the transition 48, the occluded portion 47 of the center conductor 42 overlaps a portion of each of the horizontal slabline 41 and the vertical slabline 43 as shown in FIG. 5B. In the example shown, the width wₒ of the occluded portion 47 of the center conductor 42 is 40 percent of the nominal width w_{c} of the center conductor 42. The center conductor 42 is shown to have a rectangular cross-section for the purpose of illustration. The center conductor 42 alternatively has a round cross-section, or any other feasible cross-sectional shape.

According to one embodiment selected dimensions of the slabline structure 40 (shown in millimeters) are as follows:
Wₕ=9
Wᵥ=1
Wₜ=1
Hₕ=0.8
Hᵥ=2.0
Hₜ=0.8

According to alternative embodiments of the slabline structure 40, the selected dimensions have different values. In addition, alternative height and widths between the horizontal slabline 41, the transition 48 and the vertical slabline 43, and alternative widths and configurations for the center conductor 47 can be provided to achieve a designated impedance value or other electrical performance, or the dimensions and configurations can be selected to accommodate fabrication specifications for the slabline structure 40. In embodiments wherein Wₕ>>Hₕ or wherein Hᵥ>>Wᵥ, polyiron can be included in portions of the slabline structure 40 to reduce resonances or undesired transmission modes in the slabline structure 40.

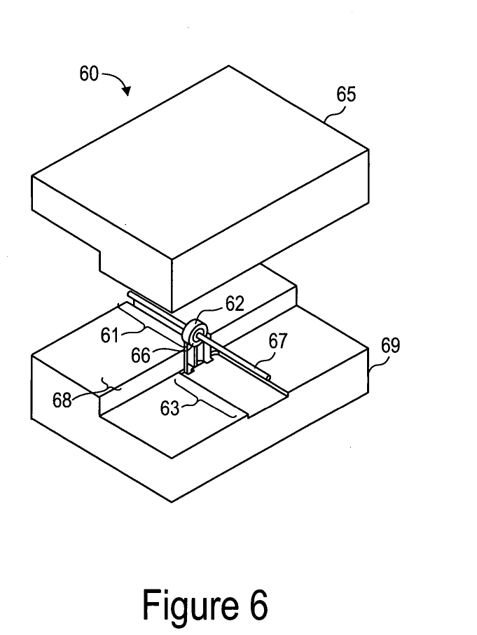

FIG. 6 shows alternative embodiments of a slabline structure 60 wherein the grounds for the transition 68 are alternatively defined by a circular, conical, square, rectangular, or other-shaped conductive frame 62 embedded or otherwise positioned within a lid 65 and a housing 69 of the slabline structure 60. In the example shown in FIG. 6, the conductive frame 62 is circular and includes an internal dielectric material 66 that provides mechanical support for a center conductor 67 for a first slabline 61, a transition 68, and the second slabline 63 in the slabline structure 60.

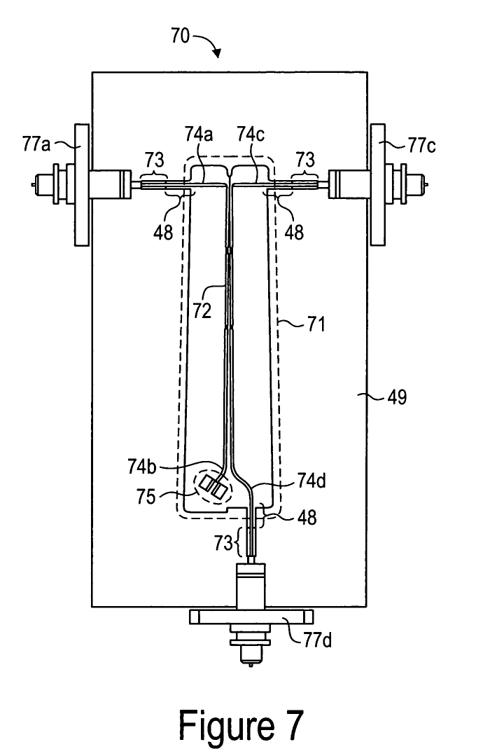

FIG. 7 shows a slabline structure 70 according to alternative embodiments of the present invention wherein a coupler 72 is implemented in a horizontal slabline 71. In one example, the horizontal slabline 71 includes coupled ports 74a, 74b and through ports 74c, 74d. A transition 48 is included at each of the ports 74a, 74c, 74d and each transition 48 is coupled to a vertical slabline 73. In one example, three of the vertical slablines 73 interfaces with a corresponding coaxial connector 77a, 77c, 77d. One of the ports 74b interfaces with a load termination 75.

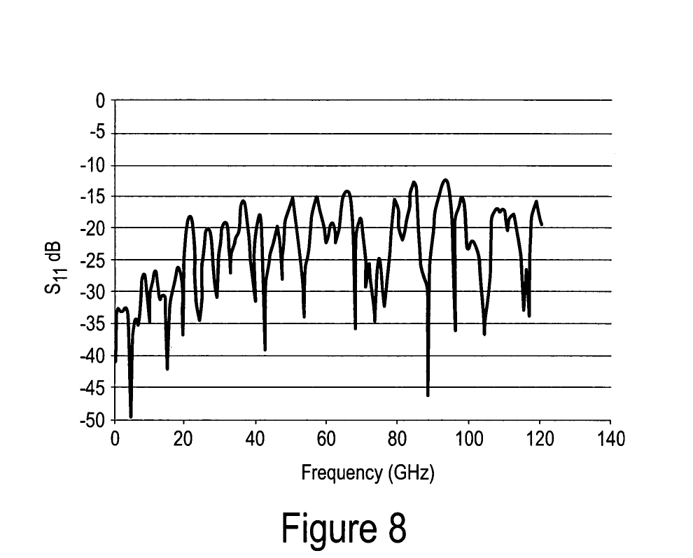

FIG. 8 shows an example of a reflection S-parameter S₁₁ of a slabline structure wherein the first slabline 41, the transition 48, and the second slabline 43 are each through lines having a nominal characteristic impedance of 50 ohms. In this example, the reflection S-parameter S₁₁ is lower than −14 dB at frequencies less than 80 GHz, indicating that the slabline structure 40 provides for a matched impedance.

While the embodiments of the present invention have been illustrated in detail, it should be apparent that modifications and adaptations to these embodiments may occur to one skilled in the art without departing from the scope of the present invention as set forth in the following claims.

1. A slabline structure, comprising:
a first slabline having a first orientation;
a second slabline having a second orientation that is rotationally offset from the first orientation; and
a transition interposed between the first slabline and the second slabline providing an impedance match between the first slabline and the second slabline.

2. The slabline structure of claim 1 wherein the first slabline is a horizontal slabline and the second slabline is a vertical slabline.

3. The slabline structure of claim 2 wherein the first slabline includes at least one of a coupler and a filter.

4. The slabline structure of claim 1 wherein the second slabline is coupled to one of a coaxial connector, an integrated circuit or a transmission line structure.

5. The slabline structure of claim 2 wherein the second slabline is coupled to one of a coaxial connector, an integrated circuit or a transmission line structure.

6. The slabline structure of claim 3 wherein the second slabline is coupled to one of a coaxial connector, an integrated circuit or a transmission line structure.

7. The slabline structure of claim 1 wherein the transition includes a center conductor and a series of one or more grounds disposed about the center conductor.

8. The slabline structure of claim 7 wherein the first slabline, the second slabline, and the transition include grounds formed within a housing and a lid.

9. The slabline structure of claim 8 wherein the transition includes a conductive frame positioned within the housing and the lid, and wherein the center conductor is suspended by a dielectric disposed about the center conducter and interposed between the center conductor and the conductive frame.

10. The slabline structure of claim 9 wherein the conductive frame has a circular cross-section.

11. A slabline structure, comprising:
a first slabline including at least one port, the first slabline having a first orientation;
a second slabline coupled to each of the at least one ports, the second slabline coupled to each of the at least one ports having a second orientation that is rotationally offset from the first orientation; and
a transition interposed between each of the at least one ports of the first slabline and the second slabline coupled to each of the at least one ports.

12. The slabline of claim 11 wherein the first slabline is a horizontal slabline.

13. The slabline of claim 12 wherein the second slabline is a vertical slabline.

14. The slabline of claim 12 wherein the first slabline includes at least one of a coupler and a filter.

15. The slabline of claim 13 wherein the first slabline includes at least one of a coupler and a filter.

16. The slabline of claim 7 wherein the second slabline coupled to each of the at least one ports of the first slabline interfaces with a coaxial connector.

17. The slabline structure of claim 11 wherein the transition includes a center conductor and a series of one or more grounds disposed about the center conductor.

18. The slabline structure of claim 17 wherein the first slabline, the second slabline, and the transition include grounds formed within a housing and a lid.

19. The slabline structure of claim 18 wherein the transition includes a conductive frame positioned within the housing and the lid, and wherein the center conductor is suspended by a dielectric disposed about the center conducter and interposed between the center conductor and the conductive frame.

20. The slabline structure of claim 19 wherein the conductive frame has a circular cross-section.
